(19) United States
(12) Patent Application Publication
(10) Pub. No.: US 2007/0053288 A1
(43) Pub. Date: Mar. 8, 2007

(54) WIRELESS COMMUNICATION METHOD AND APPARATUS FOR SELECTING A CHANNEL TYPE FOR A CALL

(75) Inventors: Janet Stern-Berkowitz, Little Neck, NY (US); Douglas R. Castor, Norristown, PA (US); Catherine M. Livet, Montreal, QC (CA); Charles A. Dennean, Melville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/459,491

(22) Filed: Jul. 24, 2006

Related U.S. Application Data
(60) Provisional application No. 60/702,649, filed on Jul. 26, 2005.

(51) Int. Cl. H04L 12/26; H04Q 7/00

(52) U.S. Cl. 370/229; 370/329

(57) ABSTRACT

Wireless communication method and apparatus for selecting a channel type for a call are disclosed. In a wireless communication system that supports both a basic low speed channel and a special high speed channel, when a call is received from a user, it is determined whether the high speed channel is suitable for the call and preferable for the user. If so, it is determined whether the high speed channel is available. If so, the call is admitted and assigned to the high speed channel. If these criteria are not met, the call is admitted and assigned a low speed channel if an available low speed channel can support the call; otherwise the call request is rejected. After admitting the call, it is continuously determined whether the high speed channel or the low speed channel is best, and the channel type is switched accordingly.

### CROSS REFERENCE TO RELATED APPLICATION

This application claims the benefit of U.S. Provisional Application No. 60/702,649 filed Jul. 26, 2005, which is incorporated by reference as if fully set forth.

### FIELD OF INVENTION

The present invention is related to wireless communication systems. More particularly, the present invention is a wireless communication method and apparatus for selecting a channel type for a call.

### BACKGROUND

Wireless communication systems have been improved to increase capacity and enhance system performance and throughput. For example, in universal mobile telecommunication services (UMTS) frequency division duplex (FDD), high speed downlink packet access (HSDPA) has been introduced to increase the throughput over the basic dedicated channels (DCHs) by more than five (5) times. In a system supporting both HSDPA channels and DCHs, it is necessary to provide a method to decide which channels to use when a new call arrives and a method to change channel usage if conditions warrant such a change.

High speed channels, such as HSDPA channels, are not always best suited for high speed data applications. Testing has shown that the high speed channels tend to be more efficient for the system and user under good channel conditions, but may not be best suited under other conditions, such as cell edge, high interference, or when a mobile unit is moving at high speed. These additional factors should be considered when assigning channels to a new call, or to move a connection from high speed channels to low speed channels during a call if the high speed channel conditions change (e.g., yielding poor performance). For a call initially assigned to a low speed channel (e.g., due to poor channel conditions or non-availability of high speed resources to support the additional service), it is desirable to switch the call to a high speed channel, if the call conditions improve and reach the required conditions for high speed channels and if high speed resources are available.

### SUMMARY

The present invention is a wireless communication method and apparatus for selecting a channel type for a call In a wireless communication system that supports both a basic low speed channel and a special high speed channel, when a call request is received from a user, it is determined whether a high speed channel is suitable for the call. If the high speed channel is suitable for the call, it is further determined whether the high speed channel is preferable for the user. If the high speed channel is preferable for the user, it is determined whether the high speed channel is available. If there is an available high speed channel, the call is admitted and assigned to the high speed channel. If these criteria for using a high speed channel are not met, the call is admitted and assigned a low speed channel if an available low speed channel can support the call; otherwise the call request is rejected. After admitting the call, it is continuously determined whether the high speed channel or the low speed channel is best, and the channel type is switched accordingly.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a state diagram for dynamically choosing the most suitable channel in accordance with the present invention;

FIG. 2 is a block diagram of a wireless communication system configured in accordance with the present invention;

FIG. 3 is a flow diagram of a process for selecting a channel type for a new call in accordance with the present invention;

FIG. 4 is a flow diagram of a process for switching a channel type after a call is setup in accordance with the present invention; and

FIG. 5 is a detailed flow diagram of a process for switching a channel type during a call in accordance with the present invention.

### DETAILED DESCRIPTION OF THE PREFERRED EMBODIMENTS

When referred to hereafter, the terminology “wireless transmit/receive unit” (WTRU) includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point (AP) or any other type of interfacing device in a wireless environment.

The features of the present invention may be incorporated into an integrated circuit (IC) or be configured in a circuit comprising a multitude of interconnecting components. The features of the present invention may be implemented in hardware, software, firmware or any combination of hardware, software and/or firmware.

The present invention provides a method for dynamically selecting the most suitable channel between a special channel and a basic channel. A number of factors are considered to select one of the special channel and the basic channel. The factors include, but are not limited to, call parameters and external conditions, (such as operating environment).

Hereinafter, the present invention will be described with reference to an HSDPA channel and a dedicated physical channel (DPCH) as an example of the special channel and the basic channel, respectively. It should be noted that these channel types are provided as an example and the present invention may be applied to any type of channels that now exist or will be developed in the future, such as third generation partnership project (3GPP) high speed uplink packet access (HSUPA) channels.

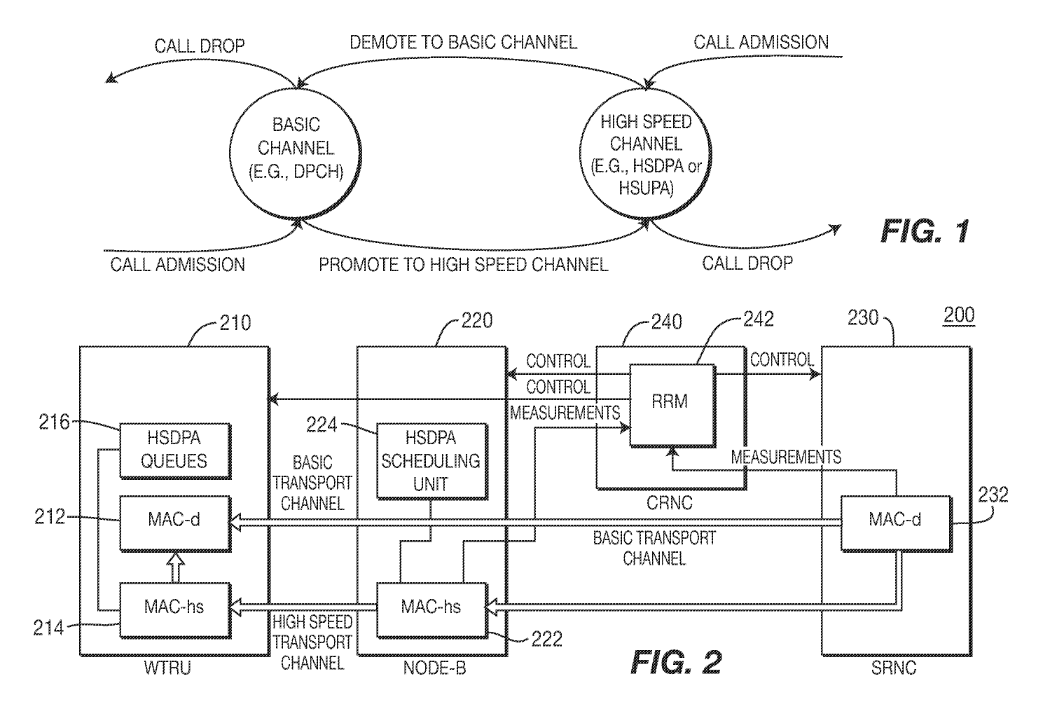

FIG. 1 is a state diagram for dynamically choosing the most suitable channel in accordance with the present invention. Upon a call admission request, first it is checked whether a high speed channel, (e.g., an HSDPA channel or an HSUPA channel), is suitable. If the high speed channel is suitable, the call admission request may be admitted to the high speed channel.

If the high speed channel is not suitable, the call admission request may be admitted to a basic channel, (e.g., a DPCH), if suitable. If the basic channel is not suitable, the call admission request is rejected. If the call is admitted and either a high speed channel or a basic channel is assigned, appropriate criteria are continuously evaluated to determine whether to promote from the basic channel to the high speed channel, demote from the high speed channel to the basic channel, or drop the call if the basic channel is no longer suitable.

FIG. 2 is a block diagram of a wireless communication system 200 configured in accordance with the present invention. The system 200 includes a WTRU 210, a Node-B 220, a serving radio network controller (SRNC) 230 and a controlling RNC (CRNC) 240. HSDPA services are handled by high speed medium access control (MAC-hs) entities 214, 222 in the WTRU 210 and the Node-B 220, respectively, and DPCH services are handled by dedicated channel MAC (MAC-d) entities 212, 232 in the WTRU 210 and the SRNC 230, respectively. A radio resource management (RRM) entity 242 is located in the CRNC 240 for controlling the overall operation of channel selection and switching in accordance with the present invention. For both the DPCH and the HSDPA channel, which are downlink channels in this example, there may be associated signaling transmitted in the uplink and/or downlink directions on these and/or different channels. It should be noted that the CRNC 240 and the SRNC 230 may be the same entity, and the RRM entity 242 may be located in any entity, (such as the Node-B 220), or split across multiple entities, (e.g., part in the CRNC 240 and part in the Node-B 220).

A set of one or more HSDPA queues 216, called reordering queues, are located within the WTRU 210 for reception of HSDPA data. The HSDPA queues 216 are accessible to the MAC-hs entity, 214. The RRM 242 assigns a queue identifier (QID) for each queue and provides these QIDs to both the WTRU 210 and the Node-B 220. When transmitting HSDPA data, the Node-B 220 transmits the QID with the data. The RRM 242 associates a scheduling priority to each QID and provides that priority to the Node-B 220 in the form of a scheduling priority indicator (SPI). An HSDPA scheduling unit 224 located in the Node-B 220 uses the SPIs when determining to which WTRU to transmit data and what data to transmit. When using HSDPA channels for a call, the RRM 242 modifies the associated SPI(s) in accordance with the present invention and uses the value(s) of the SPI(s) to determine when to switch to DPCH channels in accordance with the present invention, which will be described in detail hereinafter.

During a call, measurements and other information are sent to the RRM entity 242 from the WTRU 210, the Node-B 220 and the SRNC 230. These measurements and other information allow the RRM entity 242 to evaluate the measured quality of service (QoS) attributes of a radio bearer against those required for the radio bearer, as well as the efficiency of the channel assignments, (e.g., whether transmit power must be very high to achieve the required QoS). When several different types of channels, (e.g., an HSDPA channel and a downlink DPCH or an HSUPA channel and an uplink DPCH), are available, the RRM entity 242 assigns the WTRU 210 to a channel that is most efficient for the system capacity while maintaining the QoS requirements for that WTRU 210.

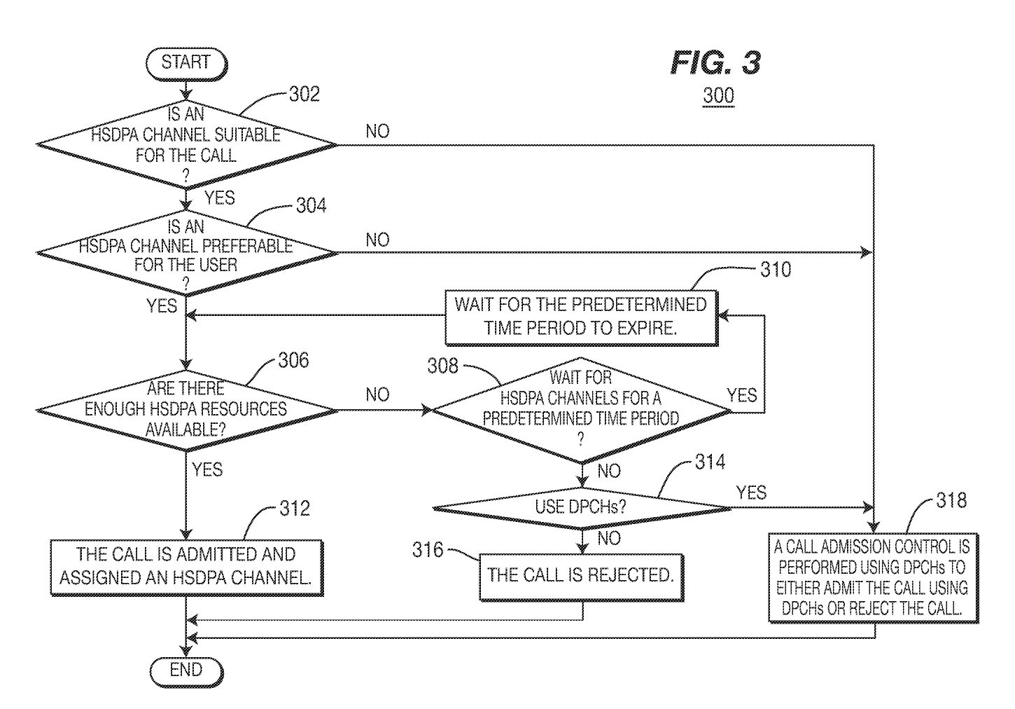

FIG. 3 is a flow diagram of a process 300 for selecting a channel type for a new call in accordance with the present invention. Upon initiation, the process begins with the QoS parameters of the call, (e.g., the radio access bearer (RAB) parameters), to determine if an HSDPA channel is suitable for the call (step 302). QoS parameters typically include, but are not limited to, maximum and/or guaranteed data rate, latency requirements, call type, and any other parameters related to the requirements of the call. Any combination of these parameters and/or other call parameters may be used to determine if an HSDPA channel is suitable for the call. If the HSDPA channel is not suitable for the call, (e.g., it is a low rate or voice call), a call admission control (CAC) is performed using DPCHs to either admit the call using DPCHs or reject the call (step 318). A CAC is a process in which either radio resources are assigned to a call or the call is rejected. Any factors can be taken into account in the CAC process, such as interference, availability of resources, or the like.

If it is determined that an HSDPA channel is suitable for the call based on the call parameters, it is then determined if the HSDPA channel is preferable for a particular user (step 304). This decision is based on factors relating to the user and the environment, such as interference measurements, predicted power requirements, user speed and cell change rate history, or the like. If the HSDPA channel is not preferable for the user, (e.g., predicted power for the user is very high), a CAC is performed using DPCHs to either admit the call using DPCHs or reject the call (step 318).

If it is determined that the HSDPA channel is preferable for the user, it is determined whether there are enough HSDPA resources available (step 306). If there are enough HSDPA resources available, the call is admitted and assigned an HSDPA channel (step 312). The HSDPA channels are shared channels and, therefore, the HSDPA channels do not need to be immediately available. HSDPA channels are considered to be available if they are able to support the addition of this service at an acceptable rate.

If it is determined at step 306 that the HSDPA channels are already congested and, therefore, there are not enough HSDPA resources available, it is determined whether to queue the service and try again after waiting for a predetermined time period to expire (step 308). If the decision at step 308 is to wait for HSDPA channels and queue the service, the process 300 waits for the predetermined time period at step 310. When the predetermined time period expires, the process 300 returns to step 306 to determine whether the HSDPA resources are available.

If the decision at step 308 is not to wait for HSDPA channels and not to queue the service, it is determined whether to use DPCHs (step 314). If the decision at step 314 is to not use DPCHs, the CAC for the call fails and the call is rejected (step 316). If the decision at step 314 is to use DPCHs for the call, a CAC is performed using the DPCHs to either admit the call using DPCHs or reject the call (step 318).

In step 308, the criteria for determining whether or not to wait for HSDPA channels to become available may be fixed, (e.g., wait always or never wait), or variable, (e.g., wait a maximum of N waiting periods, where N is a predetermined value and then do not wait further to avoid looping indefinitely through steps 306,308, 310).

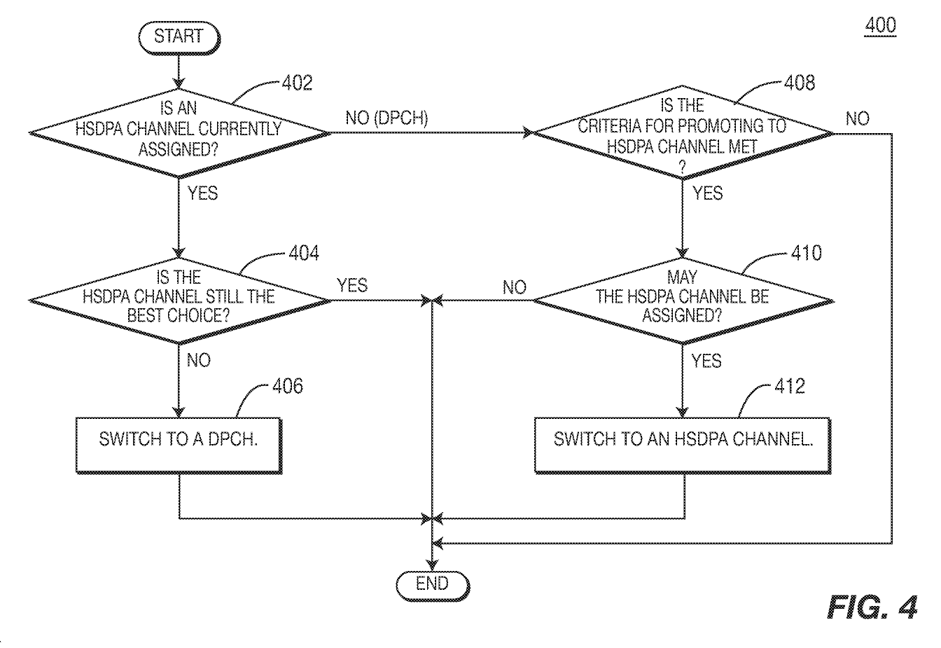

Once the call has been setup, the call is continuously monitored and a decision as to whether to stay with the selected channel type or make a switch to another type of channel is made based on appropriate criteria. FIG. 4 is a flow diagram of a process 400 for selecting a channel type after a call is setup in accordance with the present invention. First, it is determined whether an HSDPA channel is currently assigned (step 402). If an HSDPA channel is currently assigned, it is determined whether the HSDPA channel is still the best choice (step 404). If so, the HSDPA channel is maintained and the process 400 ends. If not, a switch is made to a DPCH (step 406). If it is determined at step 402 that a DPCH channel is currently assigned, it is determined if the criteria for promoting to the HSDPA channel is met (step 408). The criteria for determining whether the HSDPA channel is still the best choice at step 404 and the criteria for promoting from the DPCH to the HSDPA channel at step 408 may be based on any information that is available to the RRM entity 242 including, but not limited to, a block error rate (BLER), a transmit power, throughput, and an HSDPA SPI, or the like. Any combination of one or more of these factors or other available information can be used.

If the criteria are not met at step 408, the process 400 ends. If the criteria are met at step 408, it is further determined whether an HSDPA channel may be assigned, (e.g., an HSDPA channel is not congested), (step 410). If the HSDPA channel may be assigned, a switch is made to the HSDPA channel (step 412). If it is not possible to assign an HSDPA channel, the process 400 ends.

This process 400 repeats for the duration of the call. If even the DPCH channel cannot sustain the desired QoS of the call during the call, the call may be dropped.

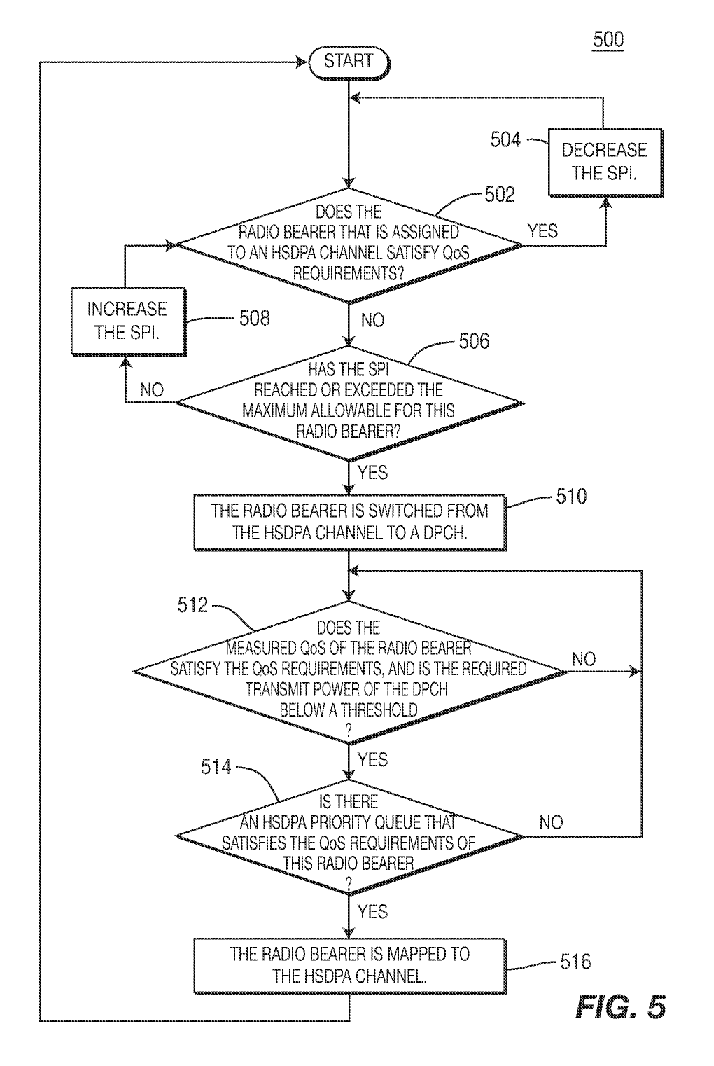

FIG. 5 is a detailed flow diagram of a process 500 for switching a channel type during a call in accordance with the present invention. It is assumed that the RRM entity 242 initially assigns a starting priority to a radio bearer that is using an HSDPA channel. For HSDPA services, all radio bearers are assigned to a specific priority. The starting priority may be chosen by any means. For example, the starting priority may be chosen to be the lowest priority or the middle priority, or the priority whose measured bit rate most closely matches the desired bit rate of the radio bearer based on the radio bearer QoS parameters. The priority may also be derived from the priorities assigned to any of the radio bearer's associated data sub-flows, (e.g., the MAC-d flows), or logical channels. An SPI indicates this priority, and the priorities are ordered from the lowest to the highest priority. The lowest priority is preferably 0 or 1. There is a maximum SPI for each radio bearer. The maximum SPI is a configurable parameter and is preferably less than or equal to 15.

As shown in step 502 of FIG. 5, it is determined if the radio bearer that is assigned to an HSDPA channel satisfies QoS requirements, (such as throughput, latency, or the like). As described above, the WTRU 210, the Node-B 220 and the SRNC 230 send measurements to the RRM entity 242. The RRM entity 242 compares the measured QoS to the required QoS based on the measurements. If the radio bearer that is assigned to an HSDPA channel meets or exceeds its QoS requirements, the SPI is decreased, (preferably by one), but not lower than the minimum priority (step 504) and the process 500 returns to step 502. If the radio bearer does not meet its QoS requirements, it is determined if the SPI has reached or exceeded the maximum allowable for this radio bearer (step 506). If the SPI has not reached or exceeded a predetermined maximum value, the SPI is increased, (preferably by one), at step 508 and the process 500 returns to step 502.

If it is determined at step 506 that the SPI reaches or exceeds the predetermined maximum value, the radio bearer is then switched from the HSDPA channel to a DPCH (step 510). Once the call is switched from the HSDPA channel to the DPCH, its QoS parameters and transmit power are monitored to determine whether the measured QoS of the radio bearer meets or exceeds QoS requirements, and the required transmit power, (or Eb/Io estimated from a signal-to-interference ratio (SIR) measurements), of the DPCH is below a threshold (step 512). The threshold is based on the desired data rate and a target block error rate (BLER). If the measured QoS meets or exceeds QoS requirements and the required transmit power of the DPCH is below the threshold, it is further determined whether there is an HSDPA priority queue that satisfies the QoS requirements of this radio bearer (as measured from the bit rate measurements, latency measurements, or the like provided by the Node-B 220) (step 514). If not, the process 500 returns to step 512 to monitor the QoS parameters and the transmit power.

If there is an HSDPA priority queue that satisfies the QoS requirements of this radio bearer, the radio bearer is mapped to the HSDPA channel, (preferably with the lowest priority queue that satisfies the QoS requirements), (step 516). If there is no HSDPA priority queue that satisfies the QoS requirements, the process 500 returns to step 512 for further monitoring. The RRM entity 242 may also drop the call if the DPCHs are insufficient to meet the QoS requirements (i.e., the cell is congested). At any time during the process 500, a separate process may be active to determine whether to drop the call based on resource availability (channels and power).

In a 3GPP FDD system, switching the channels between an HSDPA channel and a DPCH involves reconfiguration of the channels that have been setup for the call. When a WTRU 210 is assigned an HSDPA channel, a downlink DPCH carrying a dedicated control channel (DCCH) is also configured. The switch of a dedicated traffic channel (DTCH) from a high speed downlink shared channel (HS-DSCH) to a DPCH may be made by removing the assigned HSDPA resources, adding a dedicated channel (DCH) carrying the DTCH to the DPCH, and decreasing a spreading factor (SF) of the DPCH, (or increasing the number of DPCH codes), in order to increase the throughput of the DPCH. The reconfiguration of the WTRU may be performed by using a RADIO BEARER RECONFIG message. To switch back to the HSDPA channel, another reconfiguration is needed to remove the DTCH/DCH and add the HSDPA resources. This method is preferable in situations where changing between HSDPA and DPCH is infrequent, since there is an inherent delay caused by the reconfiguration. The advantage is that it maximizes code usage within the cell.

Alternatively, the DPCH can be configured with more capacity and a DCH carrying the DTCH is also configured at the same time that the HSDPA resources are allocated. The DTCH logical channel is mapped to a transport channel type of “DCH+HS-DSCH”, rather than “DCH” or “HS-DSCH” only. This allows the SRNC 230 to dynamically decide whether to map the MAC-d flow to the DCH or to the HS-DSCH (via the MAC-hs).

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system which supports a plurality of different types of channels, a method of selecting a channel type for a call, the method comprising:
(a) receiving a request for a call from a user;
(b) determining whether a first channel type is suitable for the call;
(c) determining whether the first channel type is preferable for the user if the first channel type is suitable for the call;
(d) determining whether there are sufficient radio resources available for the first channel type if the first channel type is preferable for the user;
(e) assigning resources to the call using the first channel type if the first channel type is suitable for the call, preferable for the user, and there are sufficient radio resources available for the first channel type; and
(f) performing a call admission control (CAC) for at least one other channel type if the first channel type is not suitable for the call.

2. The method of claim 1 further comprising:
performing a CAC for at least one other channel type if the first channel type is not preferable for the user.

3. The method of claim 1 further comprising:
determining whether to queue the call when there are not sufficient radio resources available for the first channel type; and
waiting for a predetermined time period to expire if it is determined to queue the call.

4. The method of claim 3 further comprising:
determining whether to try to use at least one other channel type for the call if it is determined not to queue the call;
failing the CAC for the call if it is determined not to use other channel type for the call; and
performing the CAC for the call using at least one other channel type if it is determined to use other channel type for the call.

5. The method of claim 1 wherein the determination at step (b) is based on quality of service (QoS) parameters of the call.

6. The method of claim 5 wherein the QoS parameters include at least one of a maximum data rate, a guaranteed data rate, a latency requirement and a call type.

7. The method of claim 1 wherein the determination at step (c) is based on factors relating to the user and environment.

8. The method of claim 7 wherein the factors include at least one of interference measurements, predicted power requirements, user speed history and cell change rate history.

9. The method of claim 1 wherein the first channel type is a high speed downlink packet access (HSDPA) channel and the other channel type is a dedicated physical channel (DPCH).

10. The method of claim 1 wherein the first channel type is a high speed uplink packet access (HSUPA) channel and the other channel type is a dedicated physical channel (DPCH).

11. The method of claim 1 further comprising:
determining whether a currently selected channel type is best for the call; and
switching a channel type for the call if it is determined that the currently selected channel type is not the best for the call.

12. The method of claim 11 wherein measured quality of service (QoS) parameters of the call are evaluated to determine whether to switch the call to the other channel type.

13. The method of claim 12 wherein the QoS parameters include at least one of a block error rate, a transmit power, and throughput of the call.

14. The method of claim 11 wherein the call is assigned to the first channel type with a certain priority.

15. The method of claim 14 wherein the priority is chosen to be one of a lowest priority, a middle priority and a priority whose measured quality of service (QoS) most closely matches a desired QoS of the call.

16. The method of claim 14 wherein a scheduling priority indicator (SPI) indicates the priority to which the call is assigned, the SPI is increased each time it is determined that a radio bearer for the call fails to satisfy QoS requirements, and the SPI is decreased each time it is determined that the radio bearer for the call satisfies the QoS requirements.

17. The method of claim 16 wherein the SPI is increased by one each time the radio bearer fails to satisfy the QoS requirements and decreased by one each time the radio bearer satisfies the QoS requirements.

18. The method of claim 16 wherein a maximum priority is set for the radio bearer.

19. The method of claim 18 wherein the maximum priority is not more than 15.

20. The method of claim 17 further comprising:
determining whether to switch from the first channel type to the other channel type when the SPI reaches or exceeds a predetermined maximum value.

21. The method of claim 11 further comprising:
determining whether measured QoS of the call satisfies QoS requirements and transmit power is below a threshold if the call has been switched to the other channel type;
determining whether there are sufficient radio resources available for the first channel type; and
switching the call to the first channel type if measured QoS of the call satisfies the requirements, the transmit power is below the threshold, and there are sufficient radio resources available for the first channel type.

22. The method of claim 21 wherein the call is dropped if the measured QoS does not satisfy the QoS requirements.

23. The method of claim 11 wherein a radio bearer for the call is reconfigured when the call is switched to the other channel type.

24. The method of claim 23 wherein the first channel type is a high speed downlink packet access (HSDPA) channel and the other channel type is a dedicated physical channel (DPCH).

25. The method of claim 23 wherein the first channel type is a high speed uplink packet access (HSUPA) channel and the other channel type is a dedicated physical channel (DPCH).

26. The method of claim 24 wherein reconfiguration of the radio bearer from the HSDPA channel to the DPCH is performed by reconfiguring a wireless transmit/receive unit (WTRU) to remove the HSDPA channel, adding a dedicated channel (DCH) carrying dedicated traffic channel (DTCH) to the DPCH, and decreasing a spreading factor (SF) of the DPCH or increasing the number of DPCH codes.

27. The method of claim 24 wherein reconfiguration of the radio bearer from the DPCH to the HSDPA channel is performed by removing a dedicated channel (DCH) carrying dedicated traffic channel (DTCH) and adding the HSDPA channel.

28. The method of claim 24 wherein the DPCH is configured with more capacity, and a dedicated channel (DCH) carrying dedicated traffic channel (DTCH) is configured at the same time that the HSDPA channel is allocated enabling a dedicated channel medium access control (MAC-d) flow to be switched between the DCH and an high speed downlink shared channel (HS-DSCH).

29. In a wireless communication system including a wireless transmit/receive unit (WTRU) and a Node-B, wherein the system supports a plurality of different types of channels, an apparatus for selecting a channel type for a call between different channel types, the apparatus comprising:
a receiver configured to receive a request for a call from a user; and
a radio resource management (RRM) unit configured to determine whether a first channel type is suitable for the call, determine whether the first channel type is preferable for the user, and determine whether there are sufficient radio resources available for the first channel type, configured to assign resources using the first channel type if the first channel type is suitable for the call, preferable for the user, and there are sufficient radio resources available for the first channel type, and configured to perform a call admission control (CAC) for at least one other channel type if the first channel type is not suitable for the call.

30. The apparatus of claim 29 wherein the RRM unit is configured to perform a CAC for at least one other channel type if the first channel type is not preferable for the user.

31. The apparatus of claim 29 wherein the RRM unit is configured to determine whether to queue the call when there are not sufficient radio resources available for the first channel type and wait for a predetermined time period to expire if it is determined to queue the call.

32. The apparatus of claim 31 wherein the RRM unit is configured to determine whether to try to use at least one other channel type for the call if it is determined not to queue the call, fail the CAC for the call if it is determined not to use the other channel type for the call, and perform the CAC for the call using at least one other channel type if it is determined to use the other channel type for the call.

33. The apparatus of claim 29 wherein the RRM unit determines whether the first channel type is suitable for the call based on quality of service (QoS) parameters of the call.

34. The apparatus of claim 33 wherein the QoS parameters include at least one of a maximum data rate, a guaranteed data rate, a latency requirement and a call type.

35. The apparatus of claim 29 wherein the RRM unit determines whether the first channel type is preferable for the user, based on factors relating to the user and environment.

36. The apparatus of claim 35 wherein the factors include at least one of interference measurements, predicted power requirements, user speed history and cell change rate history.

37. The apparatus of claim 29 wherein the first channel type is a high speed downlink packet access (HSDPA) channel and the other channel type is a dedicated physical channel (DPCH).

38. The apparatus of claim 29 wherein the first channel type is a high speed uplink packet access (HSUPA) channel and the other channel type is a dedicated physical channel (DPCH).

39. The apparatus of claim 29 wherein the RRM unit is configured to determine whether a currently selected channel type is best for the call and switch a channel type for the call if it is determined that the currently selected channel type is not the best for the call.

40. The apparatus of claim 39 wherein measured quality of service (QoS) parameters of the call are evaluated to determine whether to switch a channel type for the call.

41. The apparatus of claim 40 wherein the QoS parameters include at least one of a block error rate, a transmit power and throughput.

42. The apparatus of claim 39 wherein the call is assigned to the first channel type with a certain priority.

43. The apparatus of claim 42 wherein the priority is chosen to be one of a lowest priority, a middle priority and a priority whose measured quality of service (QoS) most closely matches a desired QoS of the call.

44. The apparatus of claim 42 wherein a scheduling priority indicator (SPI) indicates the priority to which the radio bearer is assigned and the SPI is increased each time it is determined that a radio bearer for the call fails to satisfy QoS requirements and the SPI is decreased each time it is determined that the radio bearer for the call satisfies the QoS requirements.

45. The apparatus of claim 44 wherein the SPI is increased by one each time the radio bearer fails to satisfy the QoS requirements and decreased by one each time the radio bearer satisfies the QoS requirements.

46. The apparatus of claim 44 wherein a maximum priority is set for the radio bearer.

47. The apparatus of claim 46 wherein the maximum priority is not more than 15.

48. The apparatus of claim 45 wherein the RRM unit is configured to determine whether to switch to the other channel type when the SPI reaches or exceeds the maximum.

49. The apparatus of claim 39 wherein the RRM unit is configured to determine whether measured QoS of the call satisfy QoS requirements and transmit power is below a threshold if the call has been switched to the other channel type, determine whether there are sufficient radio resources available for the first channel type, and switch the call to the first channel type if measured QoS of the call satisfy the QoS requirements, the transmit power is below the threshold, and there are sufficient radio resources available for the first channel type.

50. The apparatus of claim 49 wherein the call is dropped if the measured QoS do not satisfy the QoS requirements.

51. The apparatus of claim 39 wherein a radio bearer for the call is reconfigured when the call is switched to the other channel type.

52. The apparatus of claim 51 wherein the first channel type is a high speed downlink packet access (HSDPA) channel and the other channel type is a dedicated physical channel (DPCH).

53. The apparatus of claim 51 wherein the first channel type is a high speed uplink packet access (HSUPA) channel and the other channel type is a dedicated physical channel (DPCH).

54. The apparatus of claim 52 wherein reconfiguration of the radio bearer from the HSDPA channel to the DPCH is performed by reconfiguring a WTRU to remove the HSDPA channel, adding a dedicated channel (DCH) carrying dedicated traffic channel (DTCH) to the DPCH, and decreasing an spreading factor (SF) of the DPCH or increasing the number of DPCH codes.

55. The apparatus of claim 52 wherein reconfiguration of the radio bearer from the DPCH to the HSDPA channel is performed by removing a dedicated channel (DCH) carrying a dedicated traffic channel (DTCH) and adding the HSDPA channels.

56. The apparatus of claim 52 wherein the DPCH is configured with more capacity and a dedicated channel (DCH) carrying dedicated traffic channel (DTCH) is configured at the same time that the HSDPA channels are allocated enabling a dedicated channel medium access control (MAC-d) flow to be switched between the DCH and a high speed downlink shared channel (HS-DSCH).
